(19) United States
(12) Patent Application Publication
(10) Pub. No.: US 2008/0066841 A1
(43) Pub. Date: Mar. 20, 2008

(54) Pneumatic tire with tie bars

(75) Inventor: Daniel Stephen Mathews, Mount Vernon, IL (US)

Correspondence Address: CONTINENTAL TEVES, INC., ONE CONTINENTAL DRIVE, AUBURN HILLLS, MI, 48326-1581, US

(73) Assignee: Continental Tire North America, Inc.

(21) Appl. No.: 11/519,718

(22) Filed: Sep. 12, 2006

(51) Int. Cl. B60C 11/13

(52) U.S. Cl. 152/209.22

(57) ABSTRACT

A tire tread (1) includes tie bars (13,14,15,16) in its secondary grooves (9,10,11,12). These tie bars (13,14,15,16) are rounded and taper off on their sides so that the contour of such a tie bar (13,14,15,16) in cross-section along a groove (9,10,11,12) constitutes a continuous curve without edges or straight lines. The profile of the tie bar (13) is essentially a circle segment with sides leveling off toward the bottom of the groove (12). This design allows a gradual change in block stiffness unlike conventional tie bars, which only provide a sudden drop-off in block stiffness.

The present invention relates to a pneumatic tire with a tread which includes tie bars between tread blocks.

Pneumatic tires such as used for passenger and light trucks, have a tread pattern which extends circumferentially about the tire. The tread usually consists of a plurality of circumferentially and laterally extending grooves which divide the tread into generally circumferentially extending ribs formed by a plurality of either continuous or discontinuous tread blocks. The tread blocks may be separated by lateral grooves or slots which connect the circumferential grooves with each other and provide for expelling water to prevent hydroplaning and provide better traction in snow and mud. To improve longevity and ride comfort and to reduce irregular wear, tread blocks separated by lateral grooves can be connected by tie bars. Tie bars are local radial elevations of the bottom of a groove between tread blocks. In these places, the groove has a reduced depth, and the two adjacent tread blocks are more rigidly connected to each other than if they were separated by a full-depth groove.

The cross-section of a tie bar along the groove is usually essentially rectangular. Its stiffness is determined by its height and width.

It is an objective of the present invention to provide a pneumatic tire with tie bars that allow for a better fine-tuning of the tie bar properties.

### SUMMARY OF THE INVENTION

This objective is achieved by providing the tire tread with tie bars, which are rounded on their sides, so that the contour of such a tie bar in cross-section along a groove constitutes a continuous rounded curve without edges or straight lines. This design allows a gradual change in block stiffness unlike conventional tie bars, which only provide a sudden drop-off in block stiffness.

The underlying shape of the tie bar profile is preferably essentially a circle segment rising from the bottom of the groove with rounded flanks leveling off toward the bottom of the groove. The desired height and width of the tie bar determines the radius of the circle.

With this design, the height of a tie bar is limited to approximately half of its width. Otherwise, there would be an undercut because the center of the circle would lie above the bottom of the groove. For such cases, an elliptical design can be chosen comprising a greater radius for the height than for the width of the tie bar to eliminate undercuts.

Accordingly, different tie bars can possess different slopes, heights, and widths.

### BRIEF DESCRIPTION OF THE DRAWINGS

In the drawings,

FIG. 1 shows a portion of a tire tread with tie bars according to the invention;

FIG. 2 shows a cross-sectional view of the tire tread of FIG. 1 along the line II-II;

FIG. 3 shows a cross-sectional view of the tire tread of FIG. 1 along the line III-III.

### DETAILED DESCRIPTION OF THE DRAWINGS

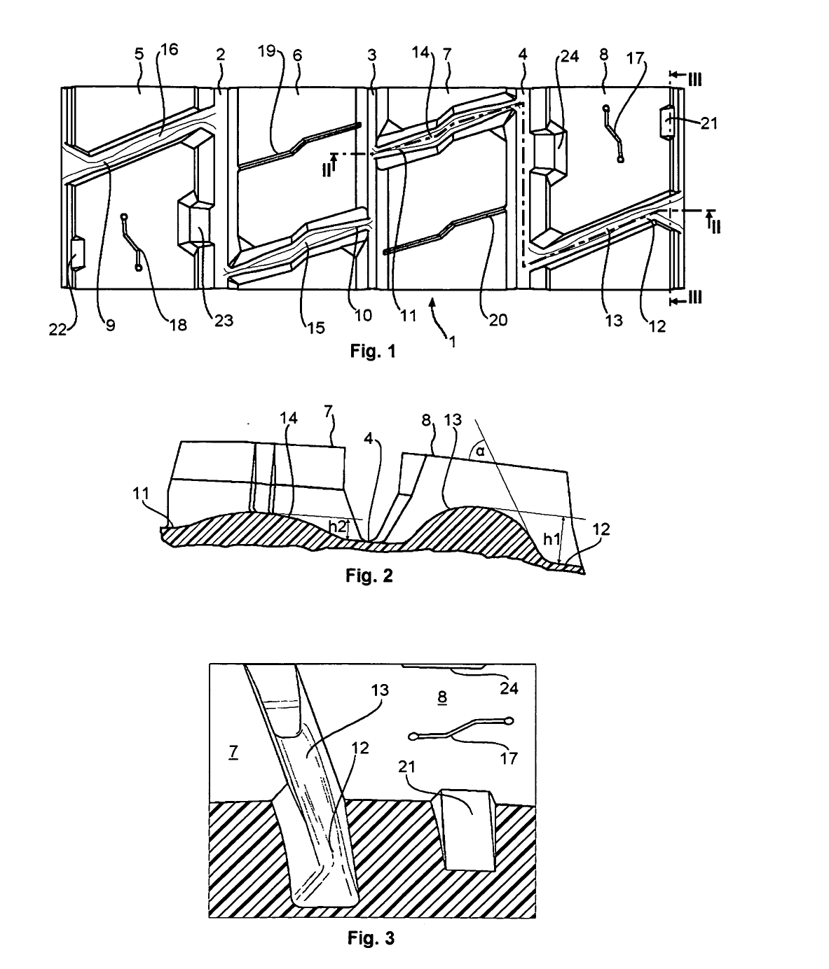

The tire tread 1 of FIG. 1 is shown in a view where the axis of rotation of the tire extends horizontally. Accordingly, the circumferential grooves 2, 3, and 4, running around the entire tire circumference, are shown in the vertical direction.

These primary, circumferential, grooves 2,3, and 4 separate tread ribs 5, 6, 7, and 8 from each other. The tread ribs 5-8 are divided into tread blocks by secondary, angled lateral, grooves 9, 10, 11, and 12, each of which connects two neighboring primary grooves with each other. In addition, various sipes 17, 18, 19, 20 are provided, a portion of which, 17 and 18, extends in essentially longitudinal direction and are closed on both ends, while others, 19 and 20, are open and arranged laterally to connect two primary grooves with each other. The two outer tread ribs 5 and 8 comprise so-called penets 21 and 22 on their axially outer edge and axial indentions 23 and 24 on their axially inner edges. Bevel relief chamfers on the leading and trailing edges of the tread blocks complete this portion of the tread pattern.

The secondary grooves 9-12 are equipped with tie bars 13, 14, 15, and 16. The shape of these tie bars 13-16 can be gathered from FIG. 2, which shows a cross-sectional view along the angled line referenced in FIG. 1 by the Roman numeral II.

The two tie bars 13 and 14 have in common that, in cross-section, they have a rounded contour, like a circle segment gradually tapering off toward the adjacent primary grooves, for instance toward groove 4.

It is evident that the tie bar 13 arranged in groove 12 of the axially more outwardly located tread rib 8 has a greater height h1 than tie bar 14 arranged in groove 11 or tread rib 7. Tie bar 13 has a height of approximately half of the tread depth. The height h2 of tie bar 14 is only about half of the height h1 of tie bar 13, i.e. approximately 15% of the tread depth. This is due to the greater forces acting on the shoulder portions of the tire tread so that the tread blocks of the outer ribs need a stiffer connection between one another. Since both tie bars have similar widths, the radius of the curvature of tie bar 13 is smaller than the radius used for tie bar 14 in order to achieve the different heights.

The flanks of tie bar 13 have a steeper slope than the flanks of tie bar 14. The maximum slope angle α of the flanks of tie bar 13 with respect to the tread surface is approximately 60°. Slope angles vary with the circle segment used to create the profile.

FIG. 3 shows tie bar 13 from a different perspective, i.e. in a cross-section indicated by the line referenced with Roman numeral III in FIG. 1. For illustration of the view, penet 21, sipe 17, and indention 24 are indicated as well. From this point of view, it is evident that the walls of groove 12 are gradually tapered in a rounded fashion to transition into the surface of tie bar 13. There are no sharp angles which might be prone to tearing. Thus the tie bar has a convex shape in cross-sectional direction, i.e. along the secondary groove, and a concave shape in longitudinal direction, i.e. across the secondary groove.

The invention is not limited to tie bars that are symmetrical and dome-shaped like the tie bars 13 and 14 shown in FIG. 2. It is possible to have a flattened or even indented center portion or flanks with different slopes on either side. The selection of such features depend on the desired physical properties of the tire tread.

What is claimed is:

1. A tire tread (1) with at least one groove (12) provided with a tie bar (13), wherein the tie bar (13) has a rounded contour and two flanks that taper off toward the bottom of the groove (12) so that the contour constitutes a continuous curve.

2. The tire tread (1) according to claim 1, wherein the profile of the tie bar (13) is essentially a circle segment with sides leveling off toward the bottom of the groove (12).

3. The tire tread (1) according to claim 1, wherein the groove (12) is a secondary groove (12) connecting two primary grooves (4) and wherein the tie bar (13) flanks gradually taper off toward the primary grooves (4).

4. The tire tread (1) according to claim 1, wherein the walls of the groove (12) gradually transition into the tie bar (13), thus giving the tie bar (13) a rounded, concave profile in a cross-sectional view across the groove (12).
